(19) United States
(12) Patent Application Publication
(10) Pub. No.: US 2016/0328480 A1
(43) Pub. Date: Nov. 10, 2016

(54) SYSTEMS AND METHODS FOR TUNING CONTENT PROVISION BASED ON USER PREFERENCE

(71) Applicant: Facebook, Inc., Menlo Park, CA (US)

(72) Inventors: Erich James Owens, Oakland, CA (US); Cemre Güngör, San Francisco, CA (US)

(21) Appl. No.: 14/705,437

(22) Filed: May 6, 2015

(51) Int. Cl. G06F 17/30; G06N 99/00

(52) U.S. Cl. CPC G06F 17/30867; G06F 17/3053; G06N 99/005

(57) ABSTRACT

Systems, methods, and non-transitory computer readable media configured to prompt a user to provide an indication of a desired frequency with which to receive content items reflecting a topic. The indication of the desired frequency can be received. A selection of the content items reflecting the topic can be tuned for presentation to the user based on the desired frequency.

### FIELD OF THE INVENTION

The present technology relates to the field of content provision. More particularly, the present technology relates to techniques for tuning selection of content for presentation based on desired frequency.

### BACKGROUND

Today, people often utilize computing devices for a wide variety of purposes. Users can use their computing devices, for example, to communicate and otherwise interact with other users. Such interactions are increasingly popular over a social network.

Some interactions in a social network may include the sharing of content. Content can be shared in a variety of manners. One example of a technique to share content with a user in a social network is a news feed. The news feed can be a sequential listing of content items (or stories) that are deemed appropriate for presentation to the user. The news feed for the user can include myriad types of content items. Such content items can include, for example, images uploaded by others in the social network of the user, descriptions of activities of connections of the user, articles regarding subject matter of interest to the user, advertisements directed to the user, etc. As the social network of the user expands and the interests of the user expressed in the social network grow more varied, the amount of content items presented in the news feed of the user can attendantly increase.

### SUMMARY

Various embodiments of the present disclosure can include systems, methods, and non-transitory computer readable media configured to prompt a user to provide an indication of a desired frequency with which to receive content items reflecting a topic. The indication of the desired frequency can be received. A selection of the content items reflecting the topic can be tuned for presentation to the user based on the desired frequency.

In an embodiment, the content items can be provided in a news feed based on the desired frequency.

In an embodiment, topics reflected by the content items can be determined.

In an embodiment, the determination of topics reflected by the content items can comprise applying machine learning to train classifiers to identify the topics.

In an embodiment, tuning selection of the content items can comprise assigning a numerical value based on the indication of the desired frequency.

In an embodiment, tuning selection of the content items can comprise combining the numerical value with a topic score of the user for the topic to generate an updated topic score. Content items reflecting the topic can be identified for presentation to the user based on the updated topic score.

In an embodiment, the indication of the desired frequency can be provided for presentation to the user.

In an embodiment, an option for the user to modify the indication of the desired frequency can be provided.

In an embodiment, the indication of desired frequency can be at least one of a user input to decrease presentation of the content items reflecting the topic and a user input to increase presentation of the content items reflecting the topic.

In an embodiment, at least one additional topic related to the topic reflected by the content items can be determined. A selection of content items reflecting the at least one additional topic can be tuned for presentation to the user based on the desired frequency.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates a system including an example content management module, according to an embodiment of the present disclosure.

FIG. 2 illustrates an example content tuning module, according to an embodiment of the present disclosure.

FIG. 3 illustrates an example user interface, according to an embodiment of the present disclosure.

FIG. 4 illustrates a first example method to tune selection of content items for presentation to a user based on a desired frequency, according to an embodiment of the present disclosure.

FIG. 5 illustrates a second example method to tune selection of content items for presentation to a user in a news feed based on a desired frequency, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Tuning Content Presented to a User Based on User Preferences

A news feed can be an effective technique to present content items (or stories) to a user. In some instances, a news feed can constitute a time ordered listing of content items presented for the user to stay apprised of events in her social network. The news feed for the user can include various types of content items. The content items can include, for example, images uploaded by others in a social network of the user, accounts of activities of connections of the user, articles regarding subject matter of interest to the user, advertisements directed to the user, etc. The amount of content items presented to the user can increase as the social network of the user swells, the interests of the user grow more varied, and the interactions of the user expand.

As the content items presented to the user in a news feed increase, the likelihood that the user will be presented with content items reflecting similar or identical topics can accordingly increase. When multiple content items reflecting a common topic are presented to the user, user experience can be enhanced when the user has significant interest in the topic. Inversely, when multiple content items reflecting a common topic are presented to the user, user experience can be compromised when the user has little interest in the topic. In the latter circumstances, repeated presentation of content items reflecting a topic in which the user has little interest can diminish the utility of the news feed. Further, the user may have little motivation to access the news feed when she expects to find a dearth of interesting information.

An improved approach to providing content items in a news feed overcomes disadvantages associated with conventional approaches. In general, systems, methods, and computer readable media of the present disclosure can perform content classification techniques to determine topics reflected by content items. The content items may be identified, ranked, and potentially selected for presentation in the new feed of a user based on a content selection technique associated with the news feed. When the user indicates decreased, little, or no interest in a particular content item presented to the user in the news feed, one or more topics reflected by the content item can be identified. Further, additional topics related to the disfavored topics reflected by the content item can be identified. The disfavored topics reflected by the content item and the additional related topics, which collectively can be considered disfavored topics, can be provided to the content selection technique to tune the consideration of content items for potential presentation to the user. In particular, the importance of the disfavored topics in the selection of content items to be included in the news feed can be downranked. As a result, the probability of appearance of content items reflecting the disfavored topics in the news feed will be decreased. The probability of appearance of content items reflecting the disfavored topics can be tuned based on the extent to which the importance of the disfavored topics is downranked. Likewise, favored topics can be upranked in an analogous manner. One of the advantages of the technology of the present disclosure is that the presentation of certain types of content items to a user in her news feed can be reduced in frequency (or eliminated) according to preferences of the user without requiring that the user completely sever ties (“unfriend” or “unfollow”) with any of her connections on a social networking system. Severing ties with connections of the user would run contrary to the goals and spirit of a social networking system to keep the world connected and would result in missed opportunities for the user and her connections to otherwise share with one another as desired.

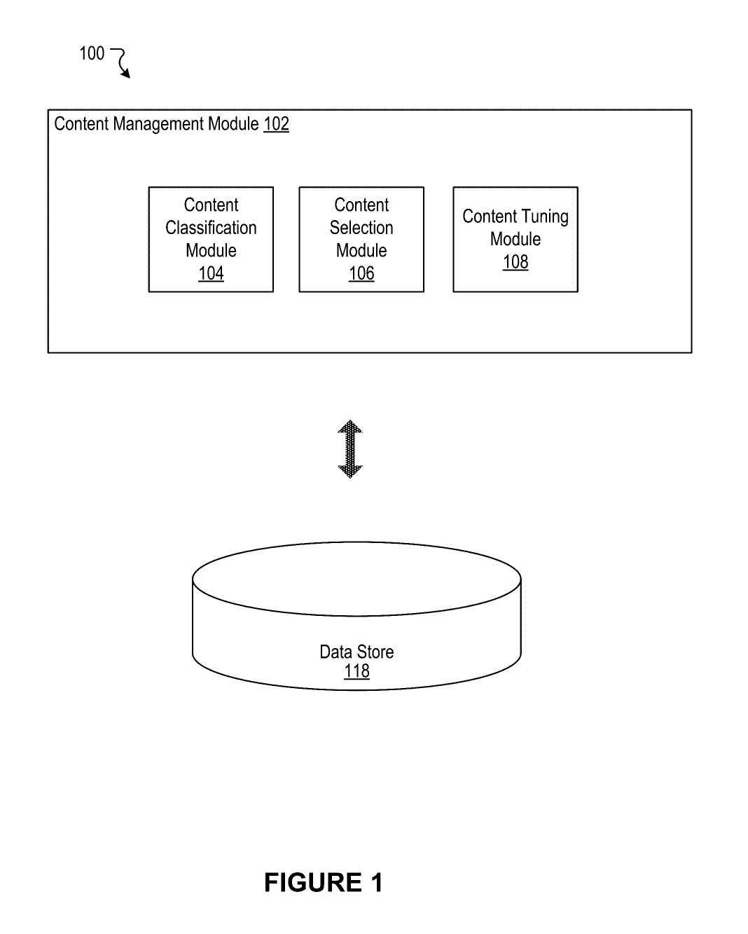

FIG. 1 illustrates an example system 100 including an example content management module 102 to allow adjustments to types of content presented to a user, according to an embodiment of the present disclosure. The content management module 102 can include a content classification module 104, a content selection module 106, and a content tuning module 108. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the content management module 102 can be implemented in any suitable combinations.

In some embodiments, as discussed herein, the present disclosure can be used in connection with a news feed managed by a social networking system that delivers content items to a user of the social networking system. In other embodiments, the present disclosure can be used in connection with content delivery techniques other than a news feed.

The content classification module 104 can perform classification analyses to determine topics (or subject matter) reflected by content items. The classification analyses performed by the content classification module 104 on content items, such as images or text, can be based on any suitable processing techniques. For example, with respect to images, an image classifier can be trained and tested to determine the subject matter reflected by an image. In a preliminary phase, contextual cues for a sample set of images can be gathered. Images classes corresponding to various subject matter can be determined. Correlation of the sample set of images with the image classes based on the contextual cues can be determined. A training set of images can be generated from the sample set of images based on scores indicative of high correlation. The training set of images can be used to train the image classifier to generate visual pattern templates of the image classes. In an evaluation phase, the image classifier can be applied to a new image to determine the image classes, which can be associated with topics, reflected by the image. The image classifier can be based on any machine learning technique, including but not limited to a deep convolutional neural network. As another example, with respect to text, topic tagging can use contextual information surrounding a content item to determine topics reflected by the content item. The contextual information can include, for example, the identities and profiles of users who interact with the content item, affinities of the users, comments provided in relation to the content item, etc. The contextual information can be used to infer topics reflected by the content item. Other suitable techniques to determine topics reflected by content items can be used.

The content selection module 106 can select content items for presentation to a user based on interests of the user. In some embodiments, the content selection module 106 can be implemented as a news feed managed by a social networking system that can select content items (or stories) for presentation to a user. In one embodiment, the content selection module 106 can train (and retrain) machine learning models for ranking content items for potential presentation in news feeds of users of a social networking system. For example, the content selection module 106 can divide its users into different sets based on various attributes of the users (e.g., age, ethnicity, income, language, etc.) and can generate one or more models for each set of users. Users with different attributes may have different behavioral patterns that can reflect their interests in different topics reflected by content items. As a result, different models for ranking content items for different sets of users can provide more accurate ranking of content items and provide higher likelihood that users will be interested in the topics reflected by the content items presented to them.

Features used to train the models can include interactions of users with content items of a news feed. Such interactions can include, for example, selecting a link in the content item, commenting on the content item, liking the content item, and hiding the content item. The content selection module 106 can use the models for each set of users to determine levels of interest of a user in topics reflected by content items. The level of interest of a user in each topic can be indicated by a topic score. The social networking system can rank a content item for potential presentation to a user based on a topic(s) reflected by the content item and the topic score(s) of the user for the topic(s). Content items having a ranking that satisfies a selected threshold value can be presented to the user in her news feed.

As discussed in more detail herein, a topic score of the user for a topic can be combined with a numerical value relating to a frequency desired by the user with which to receive content items reflecting the topic. The combination of the topic score with the numerical value relating to the desired frequency can constitute an updated topic score. In some embodiments, the updated topic score, instead of the original topic score, can be used by the content selection module 106 to rank content items for potential presentation to the user.

The content tuning module 108 can allow adjustment to the frequency with which certain types of content items are presented to a user. In some embodiments, the adjustment can be based on preferences of the user. The content tuning module 108 can monitor interactions and preferences of a user in connection with content items presented in a news feed of the user. The content tuning module 108 can determine indications of frequency desired by the user with which to receive content items reflecting certain topics. The content tuning module 108 can provide the indications of desired frequency of the user to the content selection module 106 so that the content selection module 106 can account for the indications of desired frequency in the selection of new content items to be presented to the user. The content tuning module 108 is discussed in more detail herein.

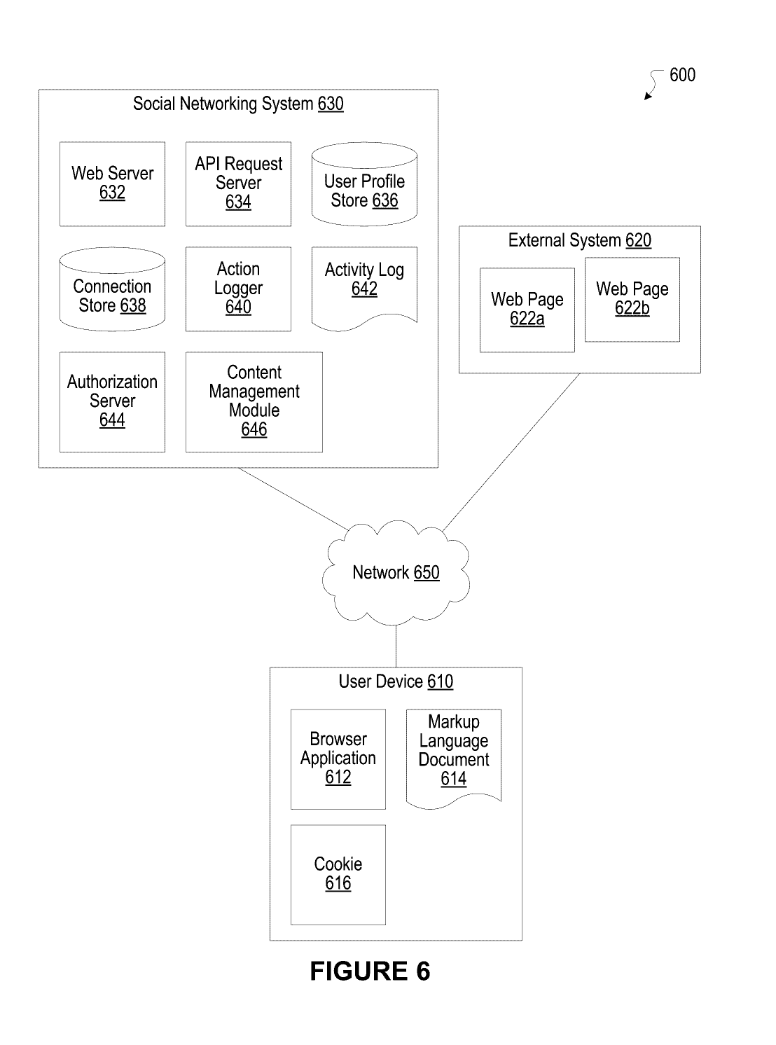

In some embodiments, the content management module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content management module 102 can be implemented, in part or in whole, as software running on one or more computing devices or systems, such as on a server or client computing device. For example, the content management module 102 can be implemented as or within a dedicated application (e.g., app), a program, or an applet running on a user computing device or client computing system. In some instances, the content management module 102 can, in part or in whole, be implemented within or configured to operate in conjunction or be integrated with a social networking system (or service), such as the social networking system 630 of FIG. 6. It should be understood that many variations are possible.

The data store 118 can be configured to store and maintain various types of data, such as the data relating to support of and operation of the content management module 102. The data can include data relating to, for example, classifiers of content items, topics reflected by the content items, topic scores of users for various topics, rankings of content items based on topic scores, indications of frequency desired by the user with which to receive content items reflecting certain topics, numerical values associated with desired frequencies, updated topic scores, etc. The data store 118 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the content management module 102 can be configured to communicate and/or operate with the data store 118.

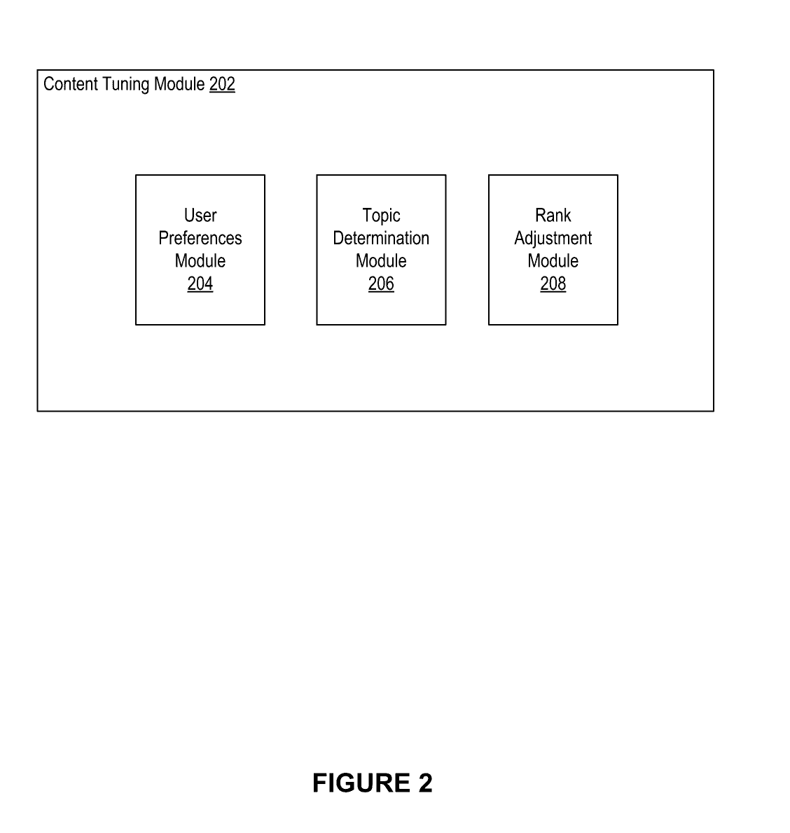

FIG. 2 illustrates an example content tuning module 202, according to an embodiment of the present disclosure. In some embodiments, the content tuning module 108 of FIG. 1 can be implemented with the content tuning module 202. As shown in the example of FIG. 2, the content tuning module 202 can include a user preferences module 204, a topic determination module 206, and a rank adjustment module 208.

The user preferences module 204 can monitor and determine preferences of a user regarding desired frequencies with which to receive content items reflecting certain topics. The preferences of the user can be indicated through user inputs provided to one or more suitable user interfaces that can be presented to the user. In some embodiments, the user interfaces can be created or supported by the user preferences module 204 along or other modules of the content management module 102 or a social networking system.

The user interfaces to prompt a user to indicate her preferences regarding a desired frequency with which to receive content items reflecting certain topics can be implemented in a variety of ways. For example, a user interface for a news feed to deliver and display content items for a user can include options for the user to dismiss (or hide) content items. The options can allow the user to dismiss one, some, or potentially all content items from the news feed. When a content item is dismissed from the news feed of a user in this manner, the user preferences module 204 can determine that the interest level of the user in the topics reflected by the content item is potentially relatively low. Similarly, as another example, a user interface for a news feed to deliver and display content items for a user can include options for the user to emphasize (or highlight) content items. The options can allow the user to emphasize one, some, or potentially all content items in the news feed. When a content item is emphasized in the news feed of a user in this manner, the user preferences module 204 can determine that the interest level of the user in the topics reflected by the content item is potentially relatively high.

The user interfaces to prompt a user to indicate her preferences regarding a desired frequency with which to receive content items reflecting certain topics also can include one or more user interfaces that reflect preferences of a user previously received by the user preferences module 204. In one example, a user interface can list the current preferences regarding desired frequency indicated by the user with respect to the topics about which the user has previously expressed a preference. The user interface can provide options for the user to modify her preferences as to none, one, some, or all of the topics. When an option is selected by the user to modify her preference regarding desired frequency as to a topic, the frequency with which content items reflecting the topic are received by the user will change accordingly, as discussed in more detail herein.

For example, a user interface can provide options for selection by the user to specify a desired frequency with which content items reflecting a topic are presented to the user. In one instance, the options can include “See Fewer”, “Normal”, and “See More”. When selected by a user, the “See Fewer” option for a topic can indicate that the user has a relatively low interest level in the topic. As a result, the content items reflecting the topic can be presented less frequently to the user based on appropriate tuning of the content selection module 106. When selected by the user, the “Normal” option for a topic can indicate that the user has a relatively medium interest level in the topic. As a result, the content items reflecting the topic will be presented without tuning of the content selection module 106. When selected by the user, the “See More” option for a topic can indicate that the user has a relatively high interest level in the topic. As a result, the content items reflecting the topic will be presented more frequently to the user based on appropriate tuning of the content selection module 106. In addition, the user preferences module 204 can determine a desired frequency with which content items posted by a connection of a user are presented to the user based on affinity between the user and the connection. For example, assume user A is a fan of basketball team A and user B is a fan of basketball team B. Assume further that the affinity between user A and user B is a relatively low value. If user B is presented with a content item relating to the topic of basketball posted by user A and, in response, user B selects an option to see fewer of such content items, the user preferences module 204 can cause the content tuning module 202 to present to user B fewer content items relating to basketball that were posted by user A, rather than present to user B fewer content items relating to basketball that were posted by any and all users. In this manner, the user preferences module 204 can account for affinity between a user and a connection of the user in determining a desired frequency with which content items posted by the connection are presented to a user.

Other options providing more granular control or less granular control over a desired frequency with which a user is to receive content items reflecting a particular topic can be provided. For example, a user interface to prompt a user to specify an indication of a desired frequency can include a user input device (e.g., dial, knob, slide bar, pick list, etc.) to select a frequency value from a range of any number (e.g., five, 10, etc.) of possible indications or corresponding frequency values.

The topic determination module 206 can determine a topic (or topics) reflected by content items for which a user has indicated a desired frequency (or desired frequencies). The topics reflected by a content item can be determined by the content classification module 104. The content classification module 104 can provide the topics reflected by the content item to the topic determination module 206.

The topic determination module 206 can identify additional topics related to the original topics determined by the content classification module 104. To enhance user experience, the topic determination module 206 can identify additional topics related to the original topics so that the additional topics can be consistently handled according to any relevant preferences of the user. For example, a user can indicate a low interest level in a topic of sports by dismissing a content item appearing in her news feed that reflects the topics of sports and football (e.g., a story regarding the Superbowl). The topic determination module 206 can identify additional topics related to the topics of sports and football that satisfy a threshold value of relational proximity to the topic of sports and football. In particular, the topic determination module 206 can identify, for example, the additional topics of baseball and professional athletes as related to the original topics of sports and football. A frequency desired by the user with which the user to receive content items reflecting the original topics also can be applied to content items reflecting the additional topics. In this example, content items reflecting the original topics of sports and football and content items reflecting the additional topics of baseball and professional athletes can be presented to the user with the same desired frequency. The topic determination module 206 can determine additional topics related to original topics based on any suitable techniques, such as topic clustering.

The rank adjustment module 208 can receive an indication of a desired frequency with which a user is to receive content items reflecting a particular topic and determine a numerical (quantitative) value for the desired frequency. The numerical value determined for the desired frequency can reflect a relative value of the desired frequency. For example, if a desired frequency can be potentially expressed or selected by the user as one of three values, such as “See Fewer”, “Normal”, and “See More”, then the rank adjustment module 208 can assign a corresponding numerical value for the desired frequency, such as 0.5, 1.0, and 1.5, respectively. As another example, if a desired frequency can be potentially expressed or selected by the user as one of five values, such as −2, −1, 0, +1, +2, the user preferences module 208 can assign a corresponding numerical value for the desired frequency, such as 0.33, 0.67, 1.00, 1.33, and 1.67. In some embodiments, any other suitable expressions or values of desired frequency along with their related numerical values can be used. The rank adjustment module 208 can provided the numerical values associated with a desired frequency for a topic to the content selection module 106 to tune the frequency with which content items reflecting the topic are presented to a user. The tuning can be based on the combination of the numerical values with topics scores to create updated topic scores, as discussed in more detail herein.

As just one example, assume that a desired frequency can be potentially indicated (or selected) by a user as one of three values, such as “See Fewer”, “Normal”, and “See More” and that the rank adjustment module 208 can assign a corresponding numerical value relating to the desired frequency, such as 0.5, 1.0, and 1.5, respectively. Assume further that the user has selected “See Fewer” for a particular topic by providing an appropriate user input to a user interface that can prompt the user for an indication of desired frequency. Based on the selection by the user, the numerical value of 0.5 relating to the desired frequency of the user and corresponding to the user selection of “See Fewer” can be provided to the content selection module 106. The provision of the numerical value of 0.5 can tune the content selection module 106 to provide less frequently to the user content items reflecting the topic. In particular, the topic score of the user for the topic can be combined with the numerical value relating to the desired frequency. In some embodiments, the numerical vale relating to the desired frequency can be multiplied with the topic score and the product of the two figures, instead of the original topic score, can be used by the content selection module 106 as an updated topic score. Because the updated topic score is smaller in value compared to the original topic score in this example, content items reflecting the topic are downranked in terms of the frequency with which they are to be presented to the user. Accordingly, such content items will appear less frequently in the news feed of the user.

As just another example, assume that a desired frequency can be potentially indicated (or selected) by a user as one of five values, such as −2, −1, 0, +1, +2 and that the rank adjustment module 208 can assign a corresponding numerical value relating to the desired frequency, such as 0.33, 0.67, 1.00, 1.33, and 1.67, respectively. Assume further that the user has selected “+2” for a particular topic by providing an appropriate user input to a user interface that can prompt the user for an indication of desired frequency. The selection of “+2” indicates that the user would like to increase the frequency of content items reflecting the topic. Based on the selection by the user, the numerical value of 1.67 relating to the desired frequency of the user and corresponding to the user selection of “+2” can be provided to the content selection module 106. The provision of the numerical value of 1.67 can tune the content selection module 106 to provide more frequently to the user content items reflecting the topic. In particular, the topic score of the user for the topic can be combined with the numerical value relating to the desired frequency. In some embodiments, the numerical vale relating to the desired frequency can be multiplied with the topic score and the product of the two figures, instead of the original topic score, can be used by the content selection module 106 as an updated topic score. Because the updated topic score is larger in value compared to the original topic score in this example, content items reflecting the topic are upranked in terms of the frequency with which they are to be presented to the user. Accordingly, such content items will appear more frequently in the news feed of the user.

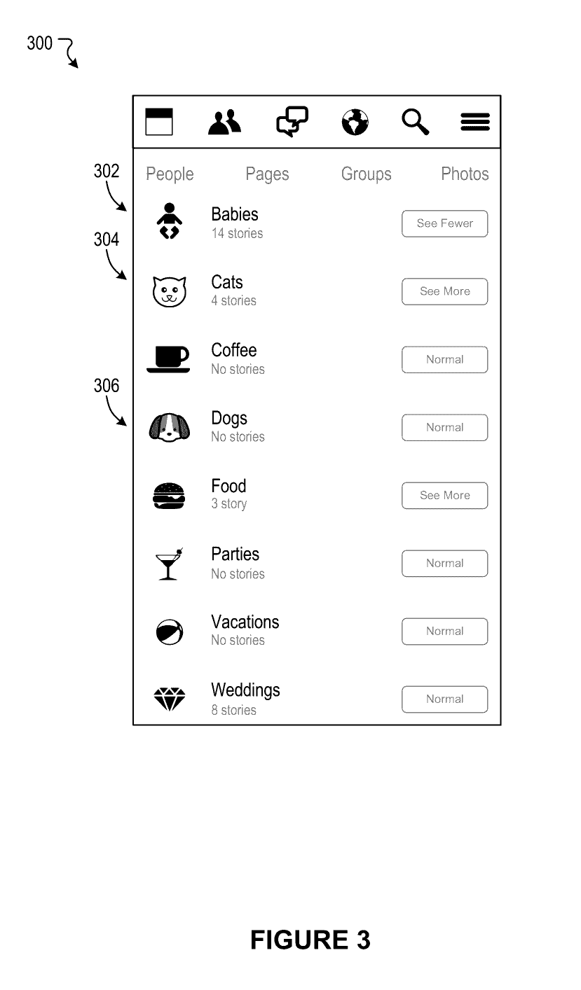

FIG. 3 illustrates an example user interface 300 to prompt a user to indicate a desired frequency with which to receive content items reflecting certain topics, according to an embodiment of the present disclosure. The user interface 300 can be presented on a computing device associated with the user. In some embodiments, the user interface 300 can be a user interface supported by the user preferences module 204 or other modules of a social networking system.

The user interface 300 can be presented to a user in a variety of circumstances. For example, the user interface 300 can be periodically presented to the user after a first time that the user has specified a desired frequency with which to receive content items reflecting a certain topic. As another example, the user interface 300 can be presented to the user each time after the user has selected an option to dismiss a content item from a news feed. As yet another example, the user interface 300 can be presented to the user each time after the user has selected an option to emphasize a content item in a news feed.

The information displayed in the user interface 300 can vary. For example, the user interface 300 can display all topics that have been determined to be relevant to the user. The determination of relevance can be, for example, based on the topics reflected by content items that have been displayed in a news feed of the user over a certain duration of time. As another example, the user interface 300 can display only those specific topics for which the user has previously indicated a desired frequency with which to receive content items reflecting those topics. In other embodiments, the user interface 300 can display topics according to other considerations.

As shown, the user interface 300 displays a listing of various topics. The topics include babies, cats, coffee, dogs, food, parties, vacations, and weddings. The user interface 300 also displays the number of content items (or stories) in the news feed of the user that reflect each topic. The user interface 300 also indicates a desired frequency previously indicated by the user with which to receive content items reflecting each topic and allows the user to modify the previously indicated desired frequency.

A row 302 in the listing of various topics relates to the topic of babies. With respect to the row 302, 14 content items in the news feed of the user reflect the topic of babies and the user previously selected the desired frequency of “See Fewer” for this topic. Accordingly, the number of content items reflecting the topic of babies presented in the news feed of the user would have been more than 14 had the user not previously selected the desired frequency of “See Fewer” for the topic of babies. The user can modify the desired frequency with which to receive content items reflecting the topic of babies by selecting “Normal” or “See More” to increase the number of content items reflecting the topic of babies that appear in her news feed. The amount of the increase in the number of content items can be based on whether the user selects “Normal” or “See More”. A row 304 in the listing of various topics relates to the topic of cats and allows the user to modify the previously selected desired frequency with which to receive content items reflecting the topic of cats (i.e., “See More”) by selecting “Normal” or “See Fewer” to decrease the number of content items reflecting the topic of cats that will appear in her news feed. A row 306 in the listing of various topics relates to the topic of dogs and allows the user to modify the previously selected desired frequency with which to receive content items reflecting the topic of dogs (i.e., “Normal”) by selecting “See Fewer” or “See More” to, respectively, decrease or increase the number of content items reflecting the topic of dogs that will appear in her news feed.

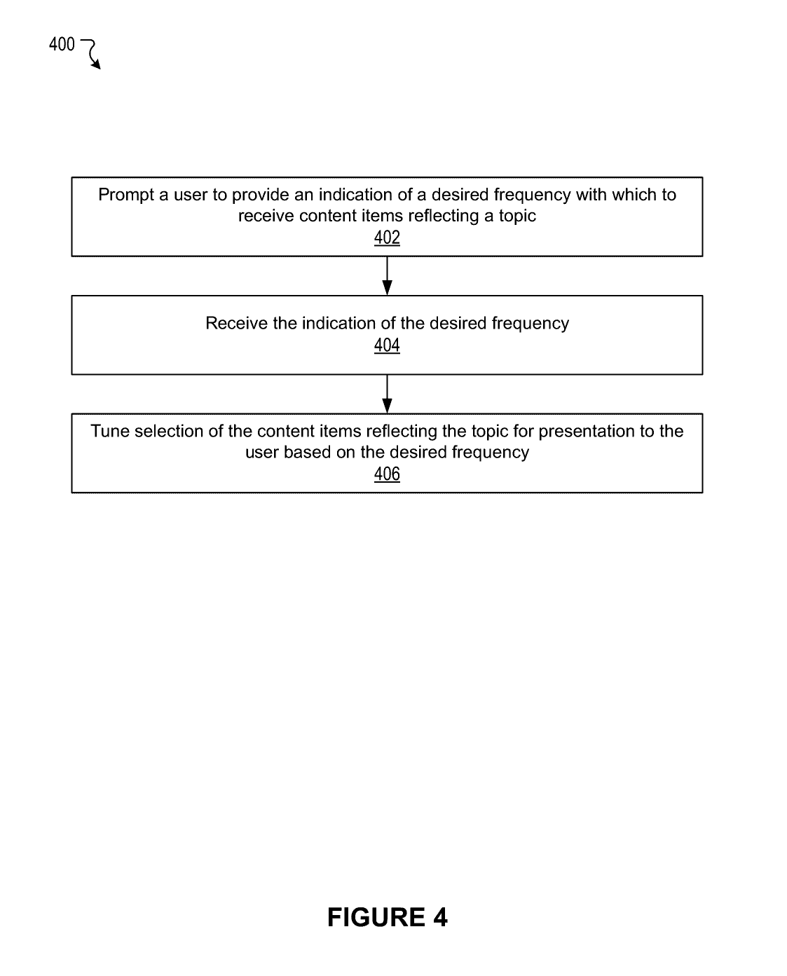

FIG. 4 illustrates an example method 400 to tune selection of content items for presentation to a user based on a desired frequency with which to receive content items reflecting a topic, according to an embodiment of the present disclosure. It should be appreciated that there can be additional, fewer, or alternative steps performed in similar or alternative orders, or in parallel, within the scope of the various embodiments unless otherwise stated.

At block 402, the method 400 can prompt a user to provide an indication of a desired frequency with which to receive content items reflecting a topic. At block 404, the method 400 can receive the indication of the desired frequency. At block 406, the method 400 can tune selection of the content items reflecting the topic for presentation to the user based on the desired frequency. Other suitable techniques that incorporate various features and embodiments of the present disclosure are possible.

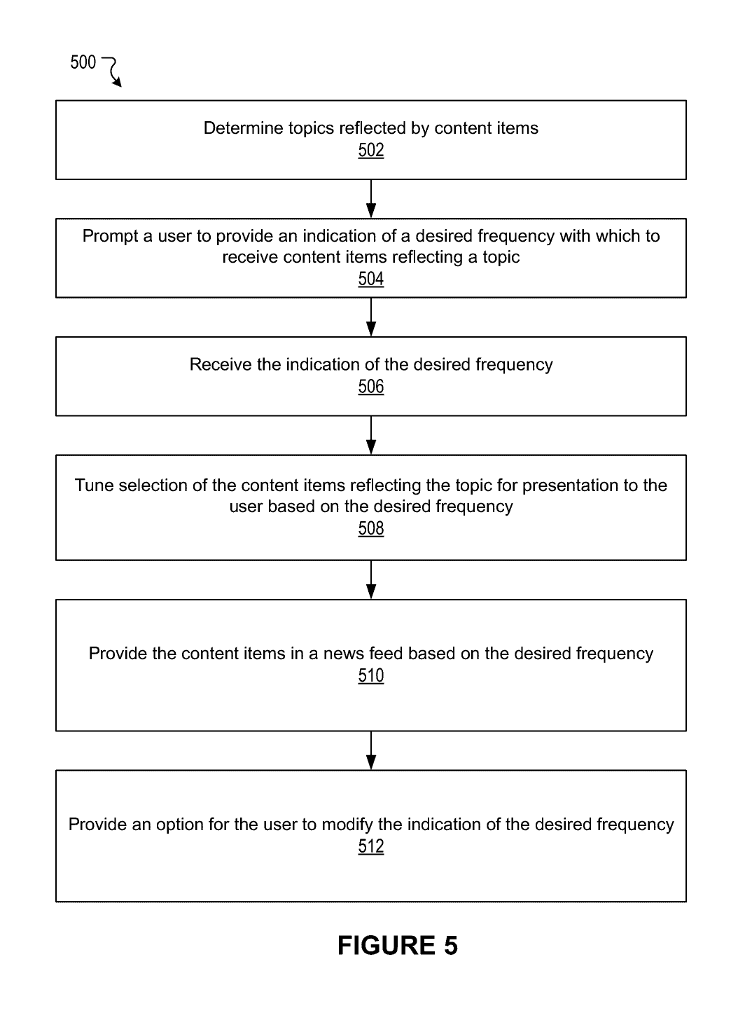

FIG. 5 illustrates an example method 500 to tune selection of content items for presentation to a user in a news feed based on a desired frequency with which to receive content items reflecting a topic, according to an embodiment of the present disclosure. It should be appreciated that there can be additional, fewer, or alternative steps performed in similar or alternative orders, or in parallel, within the scope of the various embodiments unless otherwise stated.

At block 502, the method 500 can determine topics reflected by content items. At block 504, the method 500 can prompt a user to provide an indication of a desired frequency with which to receive content items reflecting a topic. At block 506, the method 500 can receive the indication of the desired frequency. At block 508, the method 500 can tune selection of the content items reflecting the topic for presentation to the user based on the desired frequency. At block 510, the method 500 can provide the content items in a news feed based on the desired frequency. At block 512, the method 500 can provide an option for the user to modify the indication of the desired frequency. Other suitable techniques that incorporate various features and embodiments of the present disclosure are possible.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630.

An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content management module 646. The content management module 646 can be implemented with the content management module 102.

### Hardware Implementation

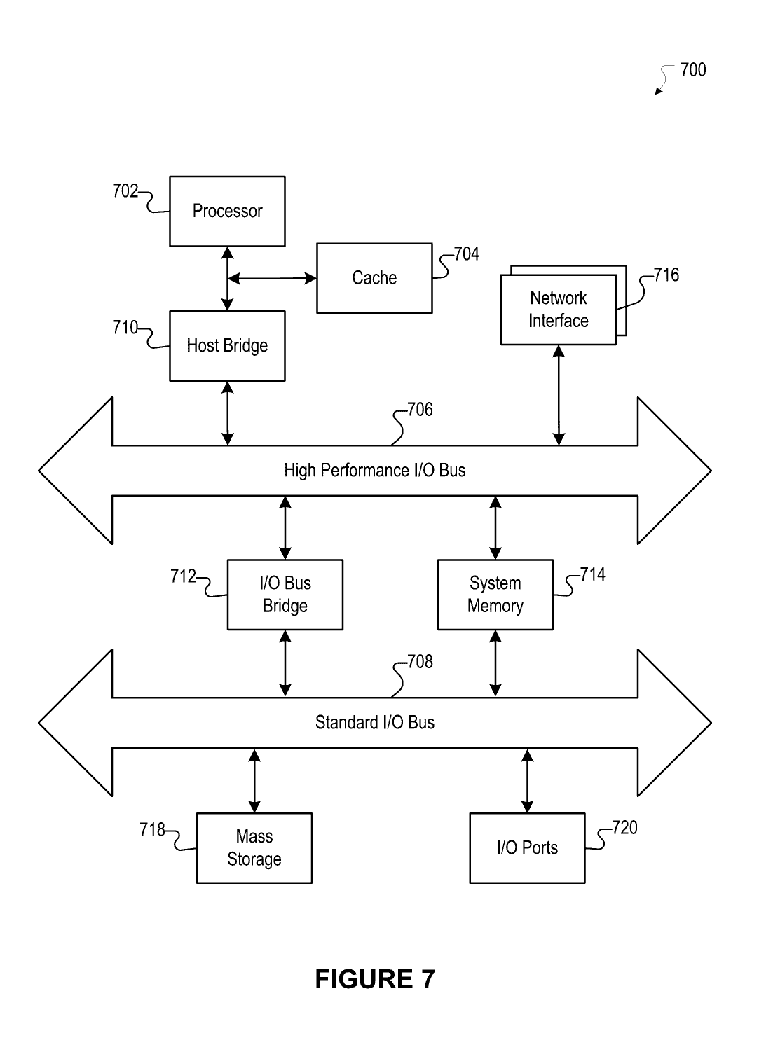

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
prompting, by a computing system, a user to provide an indication of a desired frequency with which to receive content items reflecting a topic;
receiving, by a computing system, the indication of the desired frequency; and
tuning, by the computing system, selection of the content items reflecting the topic for presentation to the user based on the desired frequency.

2. The computer-implemented method of claim 1, further comprising:
providing the content items in a news feed based on the desired frequency.

3. The computer-implemented method of claim 1, further comprising:
determining topics reflected by the content items.

4. The computer-implemented method of claim 3, wherein the determining topics reflected by the content items comprises:
applying machine learning to train classifiers to identify the topics.

5. The computer-implemented method of claim 1, wherein the tuning selection of the content items comprises:
assigning a numerical value based on the indication of the desired frequency.

6. The computer-implemented method of claim 5, wherein the tuning selection of the content items further comprises:
combining the numerical value with a topic score of the user for the topic to generate an updated topic score; and
identifying content items reflecting the topic for presentation to the user based on the updated topic score.

7. The computer-implemented method of claim 1, further comprising:
providing for presentation to the user the indication of the desired frequency.

8. The computer-implemented method of claim 1, further comprising:
providing an option for the user to modify the indication of the desired frequency.

9. The computer-implemented method of claim 1, wherein the indication of desired frequency can be at least one of a user input to decrease presentation of the content items reflecting the topic and a user input to increase presentation of the content items reflecting the topic.

10. The computer-implemented method of claim 1, further comprising:
determining at least one additional topic related to the topic reflected by the content items; and
tuning selection of content items reflecting the at least one additional topic for presentation to the user based on the desired frequency.

11. A system comprising:
at least one processor; and
a memory storing instructions that, when executed by the at least one processor, cause the system to perform:
prompting a user to provide an indication of a desired frequency with which to receive content items reflecting a topic;
receiving the indication of the desired frequency; and
tuning selection of the content items reflecting the topic for presentation to the user based on the desired frequency.

12. The system method of claim 11, further comprising:
providing the content items in a news feed based on the desired frequency.

13. The system method of claim 11, further comprising:
determining topics reflected by the content items.

14. The system method of claim 13, wherein the determining topics reflected by the content items comprises:
applying machine learning to train classifiers to identify the topics.

15. The system method of claim 1, wherein the tuning selection of the content items comprises:
assigning a numerical value based on the indication of the desired frequency.

16. A non-transitory computer-readable storage medium including instructions that, when executed by at least one processor of a computing system, cause the computing system to perform a method comprising:
prompting a user to provide an indication of a desired frequency with which to receive content items reflecting a topic;
receiving the indication of the desired frequency; and
tuning selection of the content items reflecting the topic for presentation to the user based on the desired frequency.

17. The non-transitory computer-readable storage medium of claim 16, further comprising:
providing the content items in a news feed based on the desired frequency.

18. The non-transitory computer-readable storage medium of claim 16, further comprising:
determining topics reflected by the content items.

19. The non-transitory computer-readable storage medium of claim 18, wherein the determining topics reflected by the content items comprises:
applying machine learning to train classifiers to identify the topics.

20. The non-transitory computer-readable storage medium of claim 16, wherein the tuning selection of the content items comprises:
assigning a numerical value based on the indication of the desired frequency.
